(19) United States
(12) Patent Application Publication
(10) Pub. No.: US 2024/0011128 A1
(43) Pub. Date: Jan. 11, 2024

(54) NICKEL-BASE ALLOY COMPOSITION FOR COMPONENT PARTS WITH REDUCED SUSCEPTIBILITY TO CRACKING AND OPTIMIZED HIGH-TEMPERATURE PROPERTIES

(71) Applicants: Siemens Energy Global GmbH & Co. KG,, München (DE); VDM METALS INTERNATIONAL GMBH, Altena (DE)

(72) Inventors: Kai Dörries, Braunschweig (DE); Joachim Rösler, Braunschweig (DE); Christoph Haberland, Bochum (DE); Juri Burow, Bochum (DE); Bodo Gehrmann, Plettenberg (DE); Sebastian Piegert, Lubbenau (DE)

(21) Appl. No.: 18/372,049

(22) Filed: Sep. 22, 2023

Related U.S. Application Data
(63) Continuation of application No. PCT/EP2022/057026, filed on Mar. 17, 2022.

(30) Foreign Application Priority Data
Mar. 22, 2021 (EP) 21164031.3

(51) Int. Cl. C22C 19/05; B33Y 10/00; B33Y 70/00; B22F 10/28; B33Y 40/20; B33Y 80/00; B22F 10/64; B22F 10/66

(52) U.S. Cl. CPC C22C 19/056; B33Y 10/00; B33Y 70/00; B22F 10/28; B33Y 40/20; B33Y 80/00; B22F 10/64; B22F 10/66; B22F 2999/00; B22F 2998/10; B22F 2301/15

(57) ABSTRACT

A nickel-base alloy composition includes nickel as the main constituent and the further constituents in percent by weight (% by weight): 0.04 to 0.10% carbon (C), 8 to 13% tantalum (Ta), 12 to 20% chromium (Cr), 3 to 25% cobalt (Co), less than 0.03% manganese (Mn), less than 0.06% silicon (Si), 0 to 6% molybdenum (Mo), less than 5.0% iron (Fe), 2 to 4% aluminum (Al), less than 0.01% magnesium (Mg), less than 0.02% vanadium (V), 0 to 6% tungsten (W), less than 1% titanium (Ti), less than 0.03% yttrium (Y), 0.005 to 0.015% boron (B), less than 0.003% sulfur (S), 0.005 to 0.04% zirconium (Zr) and less than 3% hafnium. Additionally provided are an additive manufacturing method, a method of additively manufacturing a component part from a powder of the alloy composition provided, a corresponding intermediate alloy, and a component part consisting of the nickel-base superalloy.

### CROSS REFERENCE TO RELATED APPLICATIONS

This application is a continuation application of international patent application PCT/EP2022/057026, filed Mar. 17, 2022, designating the United States and claiming priority to European application EP 21164031.3, filed Mar. 22, 2021, and the entire content of both applications is incorporated herein by reference.

### TECHNICAL FIELD

The present disclosure relates to a nickel-base superalloy or alloy composition, to a use thereof, and to a method of additively manufacturing a component, wherein a corresponding alloy powder is processed at least additively, to a corresponding intermediate alloy, and to a component part made from the nickel-base superalloy.

The component part is typically intended for use in the hot gas pathway of a gas turbine. For example, the component part relates to a component to be cooled that has a thin-wall or intricate design. Alternatively, or additionally, the component part may be a component for use in automobility or in the aerospace sector.

### BACKGROUND

For components such as rotor blades, guide vanes or ring segments in the hot gas pathway of gas turbines, nickel-base superalloys having a high proportion of the γ′ phase (gamma prime phase) in particular are used in order to achieve the required high-temperature stability. These alloys were originally developed as casting alloys and optimized for this production route, but they are fundamentally considered to be of reduced weldability—or even unweldable—since they tend to crack either in the welding process or else in the subsequent heat treatment. As a result, considerable challenges exist in the defect-free additive processing of such alloys, for example in the laser-based powder bed method (Laser Powder Bed Fusion, LPBF).

Alloys which have been found by experience to form a high proportion of gamma prime phase and accordingly have broad solidification intervals have an increased tendency, as a result of microsegregation effects, to be prone to hot stress cracking and solidification stress cracking during additive processing. Solidification or melting interval typically refers to the temperature interval between the solidus temperature and liquidus temperature of a substance, or of a substance phase.

Furthermore, the subsequent heat treatment required firstly to establish the desired microstructure, but secondly also to dissipate the intrinsic stresses inherent to the process, leads to further significant macroscale cracking on account of superposition of these intrinsic stresses with microstructural intrinsic stresses that arise in the heat treatment because of the change in volume in the precipitation of the γ′ phase (post weld heat treatment cracking or strain age cracking, SAC).

There is therefore barely any possibility of proper operation with the additively manufactured component parts or components mentioned that have been made from these alloys because of the defects that occur.

Turbine or machine components that are the subject of high thermomechanical stress are the subject of constant improvement, especially in order to increase their efficiency in use. In the case of thermal engines, especially gas turbines, however, this is leading to ever higher use temperatures among other effects. The metallic materials and the component design of components that can be subjected to high stress, such as turbine blades, are therefore constantly being improved with regard to their strength, lifetime, creep resistance and thermomechanical fatigue.

Additive manufacture, because of its disruptive potential for industry, is also of increasing interest for the mass production of these components.

Additive manufacturing methods (AM), also referred to colloquially as 3D printing, include, for example as powder bed methods, selective laser melting (SLM) or laser sintering (SLS), or electron beam melting (EBM).

The production of gas turbine blades with the powder bed-based methods described (LPBF) advantageously enables the implementation of new geometries, concepts, solutions and/or designs that can reduce the manufacturing costs, the construction time and lead time, optimize the production process and additionally improve thermomechanical durability of the components.

Components produced in a conventional manner, for example by casting, are distinctly inferior to the additive manufacturing route, for example with regard to their freedom of shaping and also in relation to the requisite lead time and the associated high costs and the manufacturing complexity.

Different approaches that are currently known, and are already described in the literature, are said to enable defect-reduced or even defect-free additive processing of superalloys. This includes additive processing at elevated temperatures and/or optimization of the process parameters in LPBF, for example laser output, scan speed or line spacing.

In addition, a heat treatment, for example hot isostatic pressing (HIP), may be extended or the chemical composition may be adapted in order to improve weldability.

However, the first two approaches mentioned are practicable only within certain limits. Material-specific adjustment of the irradiation parameters is required in any case; this is likewise true of alloys with relatively good suitability for welding. Depending on suitability for welding, however, the parameters may be adjusted at all only within sensible limits, namely those that permit a decent structural outcome for the component part at all. Pure optimization of the component part structure so as to overcome a susceptibility to hot cracking or solidification cracking is not possible solely via the adjustment of appropriate irradiation parameters.

Nor is it possible in this way to significantly reduce susceptibility to strain age cracking (SAC). Additive processing using high preheating temperatures, for example above 1000° C., is impossible under industrial conditions. Moreover, there are technical limitations, for example, with regard to the temperature and the associated problems arising from sintering effects. An HIP process can contribute to a certain degree to closure of heat cracks or solidification cracks present in the structure produced. However, it is not possible to close relatively large, near-surface or even open cracks at the component surface in this way, or render them harmless. Instead, such cracks would progress further in the “HIP” process. In principle, there is no means of additive powder bed-based processing (weld processing) of corresponding materials on account of the described problems with the susceptibility of corresponding alloys to cracking.

A slight adjustment to the chemical composition of already established casting and forging alloys has already been sufficiently described in the literature for solution of the effects described, and has to some degree also been implemented. This typically involves adjustments in the grain boundary-active elements, for example carbon (C), boron (B), or zirconium (Zr) or comparable elements such as silicon (Si). The aim is generally a reduction in the level of these elements.

A precipitation-hardened gamma prime superalloy based on nickel for use in a method of powder bed-based additive manufacturing is known, for example, from EP 2 886 225 B1.

Another approach for increasing suitability for welding or fundamental weldability is reduction in the level of γ′ formers. However, said approaches are generally associated with a change in high-temperature stability and/or in creep resistance and ductility. It is therefore not very productive to implement slight adjustments to the chemical compositions for alloys that have been developed for different production routes.

With the exception of the approach by Zhou et al. (Development of a New Alumina-Forming Crack-Resistant High-γ′ Fraction Ni-Base Superalloy for Additive Manufacturing. In: Tin S. et al. (eds.): Superalloys 2020, The Minerals, Metals & Materials Series), the abovementioned approaches are additionally based on the adjustment of the conventionally known casting alloy IN738 LC (“LC”=low carbon). While Zhou et al. undertake an alloy modification based on CM247, the present disclosure is the result of a completely different “ab initio” or clean sheet alloying approach where an alloy composition has been matched completely to additive processing from the outset.

### SUMMARY

It is thus an object of the present disclosure to provide a distinctly improved alloy composition matched completely to additive processing, especially powder bed-based processing, which for the first time ensures that the material class in question is suitable at all for welding and accordingly verifies for corresponding additive manufacturing routes.

The object is achieved by a nickel-base alloy composition, a method of manufacturing a component part, a method of additively manufacturing a component part, an intermediate alloy, and a component part, as described herein.

One aspect of the present disclosure relates to a nickel-base alloy, alloy composition or a preliminary form of a corresponding nickel-base superalloy in an as yet (incompletely) molten, typically pulverulent, (raw) state, including nickel as the main constituent and the further constituents in percent by weight (% by weight): 0.04 to 0.10% carbon (C), typically 0.04 to 0.07% carbon, 8 to 13% tantalum (Ta), 12 to 20% chromium (Cr), 3 to 25% cobalt (Co), less than 0.03% manganese (Mn), less than 0.03% silicon (Si), 0 to 6% molybdenum (Mo), less than 5% iron (Fe), typically less than 0.7% iron, 2 to 4% aluminum (Al), less than 0.01% magnesium (Mg), less than 0.02% vanadium (V), 0 to 6% tungsten (W), less than 1% titanium (Ti), less than 0.03% yttrium (Y), 0.005 to 0.015% boron (B), less than 0.003% sulfur (S), 0.005 to 0.04% zirconium (Zr) and less than 3% hafnium.

By contrast, in the cited publication by Zhou et al., in which a high γ′ volume content of more than 50% and a low lattice mismatch is described, the benefit of tantalum as a γ′ phase-forming element has not been recognized and the use of niobium (Nb) has additionally been suggested. In addition, a low ratio of Ta to the sum total of aluminum, niobium and titanium (Al+Nb+Ti) is suggested. Nor is the technical effect of cobalt recognized, since a cobalt-free alloy is not ruled out either. It is also apparently the aim—by contrast with the present solution (see below)—to form an aluminum oxide layer as outer layer.

The presently described alloy, by contrast, typically enables a moderate to high volume content of γ′ phase (gamma prime phase) of, for example, about 30%, and a high lattice mismatch (γ/γ′). In addition, tantalum is envisaged as the γ′ phase-forming element, which can exploit the advantageously slow precipitation kinetics. In addition, among the elements used, cobalt is used in order to lower the γ′ solvus temperature in particular, but without in the process reducing the proportion by volume at the use temperature of the component part. Furthermore, rather than aluminum, a chromium oxide layer is used as the outer layer (see Cr/Al ratio below).

In one configuration, the nickel-base alloy, alloy composition or the corresponding preliminary form of the nickel-base superalloy includes nickel as the main constituent and the further constituents in percent by weight (% by weight): 0.05 to 0.10% carbon (C), 8 to 13% tantalum (Ta), 12 to 20% chromium (Cr), 3 to 25% cobalt (Co), less than 0.03% manganese (Mn), less than 0.03% silicon (Si), 0 to 6% molybdenum (Mo), less than 0.5% iron (Fe), 2 to 4% aluminum (Al), 0.0005 to 0.1% magnesium (Mg), less than 0.02% vanadium (V), 0 to 6% tungsten (W), less than 1% titanium (Ti), less than 0.03% yttrium (Y), 0.005 to 0.015% boron (B), less than 0.002% sulfur (S), 0.005 to 0.03% zirconium (Zr) and less than 3% hafnium.

In one configuration, in the present context, the sum total of molybdenum and tungsten is 4% to 10%, the ratio of tantalum to the sum total of the elements aluminum, niobium and titanium is 1.6 to 6.5, the sum total of manganese and silicon is less than 0.03% or less than 0.07%, and/or the ratio of chromium to aluminum is between 3 and 10.

A high level of tantalum relative to the residual elements that form the γ′ phase, such as aluminum, titanium and niobium, is of high significance for resistance to strain age cracking, since tantalum diffuses much more slowly into nickel. Only when tantalum is largely responsible for the formation of the γ′ phase can the precipitation kinetics of the γ′ phase be slowed. If the ratio is below this level, this leads to too rapid precipitation kinetics, and the risk that the component part produced will fail as a result of SAC. Too high a Ta/(Al, Ti, Nb) ratio, by contrast, can have the effect that harmful secondary phases (e.g., f phases) will form.

Because of the chosen approach of slow precipitation kinetics, which is typically achieved via a relatively high Ta/Al ratio, the result is a comparatively low Al content. The relatively slow precipitation kinetics advantageously give rise at a later stage to a smaller amount of γ′ phase during the additive manufacturing and during the subsequent heat treatment(s). Therefore, the intrinsic stresses that arise as a result of the AM process can be dissipated before the superposition of intrinsic stresses by γ′ formation leads to SAC. In order still to achieve sufficiently high high-temperature oxidation and corrosion resistance, it is also necessary to choose a correspondingly high Cr content, which results in the high Cr/Al ratio specified.

A negative effect on hot stress-cracking resistance is generally ascribed to the two elements manganese and silicon. However, literature reports suggest that manganese and silicon, individually and in small amounts, could achieve a positive effect in other ways on the properties desired. For that reason, the content of the two elements is typically limited to below 0.07%.

In one configuration, the alloy composition including, in percent by weight: 0.05 or 0.04 to 0.070% carbon, 9 to 12% tantalum, 14 to 16% chromium, 8 to 21% cobalt, less than 0.01% manganese, zero or virtually zero silicon, especially apart from unavoidable residues, 2 to 3% molybdenum, less than 0.5% or 0.7% iron, 3 to 3.5% aluminum, about 0.001% magnesium, zero or virtually zero vanadium, 2 to 3% tungsten, zero or virtually zero titanium, 0 to 0.01% yttrium, 0.005 to 0.01% boron, zero or virtually zero sulfur, 0.015 to 0.025% zirconium and less than 3% hafnium.

By contrast with obvious approaches, for example the specific adjustment of individual elements of an existing casting alloy, a holistic new development approach for a novel nickel-base superalloy was thus being pursued in the present case, which addresses multiple problems. This alloy is notable for good processibility by additive manufacturing, since there is an advantageously low susceptibility to hot cracking (solidification cracking) and low susceptibility to strain age cracking (SAC), without the reduction in high-temperature resistance which is typically associated therewith. As described in the present context, this is achieved by a multitude of adjustments, including the adjustment of the solidification interval or the last progression thereof, and by solid solution solidification during the additive processing, such that the susceptibility to hot cracking is reduced thereby.

In addition, the substitution of customary γ′ formers (Ti) slows the precipitation kinetics of the γ′ phase, such that there is typically no significant precipitation, if any, in the additive beam welding process, and the harmful superposition of the process-inherent intrinsic stresses in the subsequent heat treatment with the microstructural intrinsic stresses caused by the change in volume resulting from the precipitation of the γ′ phase is reduced such that, in addition, the susceptibility to cracking by strain age cracking of the alloy is reduced.

In addition, the composition presented enables the establishment of a maximum proportion of the γ′ phase and a maximum γ/γ′ lattice mismatch by adjustment of typical and/or alternative γ′ formers, which ensures high strength and hardness of the alloy.

Furthermore, the grain boundary-active elements are adjusted in a controlled manner, such that—while still ensuring crack-free processing—there is no disadvantageous weakening of the grain boundaries and hence reduction in high-temperature strength. These elements in the case of nickel-base alloys include boron, carbon and zirconium. Being grain boundary-active elements, they accumulate at and strengthen the grain boundaries. This can advantageously prevent slipping of the grains in operation of the component part. For additive manufacture, exact matching of these elements to the residual alloy composition is important since there can otherwise be solidification or remelting cracks during processing.

The alloy presented not only enables weldability for the first time, but typically also achieves high strength, comparable to that of component parts made of IN738LC. The alloy presented is also notable for corrosion and oxidation resistance at least equivalent to the latter, since the elements required for the purpose, especially Cr and Al, are present in sufficient proportions in the alloy.

In one configuration, the alloy or alloy composition includes the above-described constituents, apart from any unavoidable impurities or residues.

A carbon content between 0.05 and 0.10% by weight results in advantageous formation of metal carbides in such nickel-base alloys. In the defined concentration, carbon typically forms here Cr₂₃C₆ and TaC. Since Cr₂₃C₆ precipitates at grain boundaries in particular, it helps to strengthen these. Metal carbides such as TaC already form in the melt, bind tantalum and other elements, and can influence “replenishment” of the melt. In this way, it is also possible for the carbides to influence solidification cracks.

Tantalum carbide (TaC) is stable even at high temperatures and cannot be completely dissolved by heat treatments. It thus hinders grain growth even at high temperatures close to the melting point, which is necessary for high creep resistance. Moreover, carbon affects solidification characteristics not only indirectly via carbide formation but also directly in that it reduces the melting point of the alloy. A range from 0.05 to 0.1% is advantageous as a good compromise between the effects of sufficient grain growth, advantageously low susceptibility to solidification cracking, and advantageously high grain boundary cohesion. A carbon content of 0.05% is particularly typical, since particularly high grain growth is thus achieved and the alloy overall is particularly robust and tolerant to a wide range of irradiation parameters, or it is possible to define a particularly robust means of processing by welding (process window).

An aluminum content between 2.0 and 4.0% by weight is necessary for the formation of the γ′ phase (typically Ni₃A₁). However, too high an aluminum content leads to an (excessively) high γ′ content or proportion by volume of γ′, which has an adverse effect on strain age cracking in heat treatments.

As well as aluminum, tantalum also forms the γ′ phase, but diffuses much more slowly. In order to keep the kinetics of the γ′ phase low, therefore, a high Ta/Al ratio is advantageous, and therefore the aluminum content likewise has to be limited. A content below 2% aluminum would lead to an excessively small proportion of the γ′ phase, which would result in inadequate mechanical properties. A content of about 3% aluminum leads to a sufficient γ′ phase content with simultaneously low susceptibility to SAC, and therefore this content is particularly typical. Raising the aluminum content is conceivable when the susceptibility to SAC is found to be sufficiently low in the individual case.

The tantalum content specified is between 8.0 and 13.0% by weight. Tantalum, alongside aluminum, is the second γ′-forming element. Too high a tantalum content leads to formation of unwanted phases, such as the η phase, and therefore the content has to be limited. In interplay with cobalt, which displaces tantalum from the γ′ matrix, the mechanical properties can be adjusted in a controlled manner. The higher the tantalum content chosen, the lower the cobalt content that typically has to be chosen, and vice versa. A content of below 8% tantalum leads to an excessively small proportion of the γ′ phase in the alloy structure, which results in inadequate mechanical properties. A tantalum content of 9% is particularly typical since this can achieve sufficient strength without cracking.

As already described, the cobalt content is typically matched inversely to the tantalum content. An excessive cobalt content leads to unwanted phases. And too low a cobalt content leads to too low a strength. Moreover, cobalt and tantalum influence the solidification interval, which likewise limits the maximum content. In combination with 9% tantalum, 19% cobalt has been found to be particularly advantageous, since strength is otherwise too low. In the case of relatively high tantalum contents, the cobalt content has to be correspondingly reduced, although 3% is the lower limit for a sufficiently high displacement effect.

Titanium, alongside tantalum, is likewise a γ′ former. However, since the diffusion rate is much higher than that of tantalum, preference is given to tantalum. Titanium can lower the oxidation stability of nickel-base alloys, which is likewise a contributing factor to the titanium content being limited to less than 1%. Titanium is typically not added to the alloy since sufficient strength can be achieved even without titanium.

Vanadium, alongside aluminum, tantalum and titanium, is likewise a γ′ former. However, since it greatly lowers oxidation stability, the content is limited to below 0.02% or, typically, vanadium is dispensed with entirely.

Chromium is used as an oxide layer former and forms an outer Cr2O3 layer which is stable up to about 900° C. This is necessary since a sufficiently high aluminum content for outer Al₂O₃ layer formation cannot be achieved owing to susceptibility to SAC. In general, the higher the chromium content, the better the stability of the outer layer as well. The chromium content is limited by the occurrence of unwanted phases. At present, 14% by weight of chromium is particularly typical, since the alloy can thus be produced efficiently and is sufficiently robust with respect to unwanted phases.

It has been found that an elevated chromium content likewise has a positive effect on susceptibility to solidification cracking, in that it ensures that the last 10% of the solidification interval can be run through more quickly. Since increasing the chromium content also leads to elevated oxidation stability, a further increase in the chromium content is conceivable. In theoretical terms, the solidification characteristics of the alloy do not change as the chromium content is increased to above 18%. However, if the level of further elements is not reduced, there will be formation of unwanted phases above 20% chromium, such as the σ phase. For that reason, the maximum chromium content is typically 20%. Alloys having a similar use temperature include at least 12% chromium for sufficient oxidation stability, which is the reason why this value is in turn adopted as the lowest limit.

Iron together with molybdenum and tungsten forms unwanted TCP phases (“topologically close packed”; also known as Frank-Kasper phases) and otherwise has no positive effect on the properties of the alloys; therefore, it is not considered as an alloy element and its content is kept below 0.05%, or limited to below 0.05%. In fact, preference is given to dispensing entirely with iron. TCP phases are among a large group of intermetallic phases that are known by virtue of their complex crystal structure and physical properties. In particular, these phases have a combination of periodic and aperiodic structures.

Molybdenum and tungsten in nickel-base alloys serve as solid solution-solidifying elements because of their high atomic radii. Too high a content leads to formation of unwanted TCP phases, and therefore the content is limited to max. 10%. Since elevated strength of the γ matrix can have a positive effect on susceptibility to solidification cracking through solid solution solidification and additionally has further technical benefits, the present alloy contains a total of typically at least 4% by weight of the two elements. The two elements show individual benefits, at least theoretically. On the one hand, molybdenum segregates more significantly than tungsten; on the other hand, it raises the solidus temperature of the residual melt. Tungsten, by contrast, segregates to a lesser degree and hence does not lead to formation of unwanted phases in the residual melt.

Magnesium serves to bind sulfur in the melt, which is important particularly in powder production and with regard to weldability. The magnesium content has to be matched as closely as possible to the sulfur content and should be between 0.0005-0.01% by weight, such that as little as possible free magnesium and sulfur remain in the alloy.

Yttrium is used in some heat-resistant Ni-base alloys in order to improve outer layer adhesion, and hence cyclical oxidation stability. Yttrium is an oxide-forming element and diffuses very slowly. Yttrium oxides are additionally very thermally stable and lead to significant dislocation anchoring. Slow diffusion and particularly strong anchoring of the dislocations at grain boundaries can improve bond strength of interfaces and lead to reduced susceptibility to cracking. Moreover, yttrium—similarly to magnesium—is capable of binding sulfur and thus has a positive effect on weldability.

Boron serves for grain boundary cohesion and has a very positive effect on creep resistance. However, it has been found that increasing the boron content to above 0.015% by weight (corresponding to 150 ppm) leads to severe solidification cracking during the AM process. A boron content below 0.005% by weight (corresponding to 50 ppm), meanwhile, leaves weak grain boundaries, such that SAC occurs on additive welding processing or subsequent heat treatments. A boron content of 70 ppm is particularly typical since it enables an advantageously large and stable process window and robust processing, and in so doing ensures adequate grain boundary cohesion.

Zirconium (zircon) is commonly ascribed the tendency to cause solidification cracks or heat cracks during the AM process, in IN738LC among other materials, which is why this element is frequently provided at a greatly reduced level in order to improve producibility. However, it has been found that the addition of 200 ppm of zirconium to the alloy in the case of a boron content of 70 ppm has a positive effect on producibility, and increases the process window. Since, like boron, it is in addition a grain boundary-active element that increases grain boundary cohesion, a minimum content of 50 ppm of zirconium is typical. Since it cannot be ruled out that an elevated zircon content will adversely affect producibility, the maximum zircon content is set at about 300 ppm.

Since boron and zirconium have similar effects, a sum total of these two elements is likewise limited to a range between 100 and 300 ppm. If the sum total is below this level, this leads to insufficient grain boundary cohesion, and if this level is exceeded to the risk of formation of heat cracks. A zirconium content of 200 ppm with 70 ppm of boron is regarded as being advantageous both for grain boundary cohesion and for producibility by welding.

Sulfur (S) has significantly detrimental effects on the properties of nickel-base alloys and therefore has to be reduced at least to a content of below 0.002% or less.

Hafnium is frequently used in nickel-base alloys for directed solidification in order to increase cross-ductility between the grains. In additively manufactured nickel-base alloys, however, it has been found that a content below 3% leads to a distinct improvement in resistance to solidification cracking, and mechanical properties can likewise improve. However, the optimal content is difficult to establish since even small variances even within the interval chosen can lead to a distinct deterioration in resistance to solidification cracking.

In one configuration of the alloy or alloy composition described, the carbon content is about 0.05% by weight, the tantalum content about 9% by weight, the cobalt content 19% by weight, the chromium content 14% by weight, the zirconium content 0.02% by weight, at a boron content of 0.007% by weight.

In one configuration, the cobalt content is or has been chosen such that no unwanted secondary phases, especially no η phase, is formed in the desired final form of the alloy present in the ultimate component part.

In one configuration, the chromium content is or has been chosen to form a stable chromium oxide layer (see above).

In one configuration, the alloy or alloy composition is in powder form.

In one configuration, the powder of the alloy is produced by gas jetting or fluid jetting, typically with the parameters described further down.

In one configuration, the alloy composition including 9 to 10% by weight of tantalum and 17 to 21% by weight of cobalt. This variant (less tantalum) is notable for improved producibility or processibility and an advantageously lower susceptibility to SAC that results from a lower γ′ content.

In an alternative configuration, the alloy composition including 10 to 12% by weight of tantalum and 8 to 10% by weight of cobalt. This variant (more tantalum), by contrast, forms a higher proportion of γ′ phase and therefore means higher high-temperature strength coupled with a simultaneously, but also larger, susceptibility to SAC.

In one configuration, moreover, a constituent of the sum total of boron and zirconium is 0.01 to 0.035 or 0.045% by weight.

In one configuration, the alloy composition—in contrast to comparable and/or conventional alloys—has a reduced γ′ solvus temperature.

A further aspect of the present disclosure relates to use of the alloy or alloy composition in an additive manufacturing method, typically laser-based and/or powder bed-based method, such as SLM, SLS and/or EBM.

A further aspect of the present disclosure relates to a method of additively manufacturing a component part, wherein a powder of the alloy or alloy composition described is at least partly (selectively and/or partially) melted with a laser or electron beam in order to produce the component part layer by layer.

In one configuration, a ready-made (by additive means) structure, especially after a hot isostatic pressing operation, is subjected to a precipitation heat treatment including solution annealing, cooling and thermal aging in order to bring about precipitation hardening.

In one configuration, the solution annealing including a heat treatment step for a period between 2 and 8 hours and within a temperature interval between 1100° C. and 1300° C.

A further aspect of the present disclosure relates to an intermediate alloy, typically a structure composed of solidified powder that has resulted directly from the additive manufacturing process, including an alloy composition as described above, wherein the intermediate alloy is free or virtually free of γ′ phase precipitates. This property specifically enables weldability because of the functional relationships described in the present document in the alloy formulation.

A further aspect of the present disclosure relates to a component part produced from the alloy or alloy composition described, the structure of which also including a high proportion of a gamma prime phase or precipitation phase and especially has an elevated γ/γ′ lattice mismatch.

Configurations, features and/or benefits that relate in the present context to the alloy composition or the corresponding superalloy may also relate directly to the additive processing or use of the composition or to the correspondingly produced component, and vice versa.

The expression “and/or” used here, when used in a series of two or more elements, means that each of the elements listed may be used alone, or it is possible to use any combination of two or more of the elements listed.

### BRIEF DESCRIPTION OF THE DRAWINGS

The disclosure will now be described with reference to the drawings wherein:

FIG. 1 shows a diagram of the dependence of the coefficient of diffusion of different alloy element constituents on the (inverse) temperature.

FIG. 2 shows, in a simplified phase diagram, the movement of a γ/γ′ phase region depending on the tantalum content of an alloy and the temperature, parametrized by the partial cobalt content (contents in percent by weight).

FIG. 3 shows a diagram of the dependence of Vickers hardness versus cobalt content in percent by weight of an alloy for a given tantalum content.

### DESCRIPTION OF EXEMPLARY EMBODIMENTS

Representations in the figures are to some degree merely schematic or illustrative and are intended merely to illustrate complex technical functional relationships of the present disclosure, without any claim to completeness.

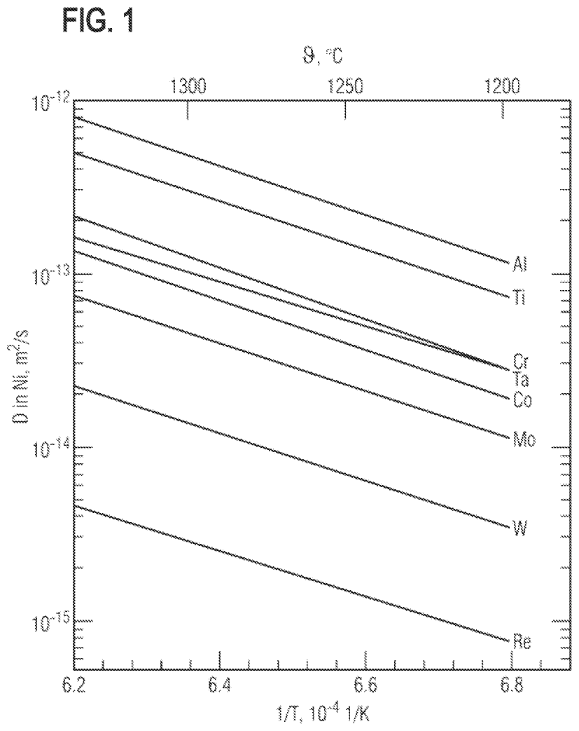

FIG. 1 shows an illustrative diagram that shows the dependence of a coefficient of diffusion D (logarithmically) of alloy elements in nickel against the logarithm of inverse temperature (at the bottom) and the temperature in ° C. (at the top). In particular, the solid state diffusion characteristics of rhenium, tungsten, molybdenum, cobalt, tantalum, chromium, titanium and aluminum in a nickel-base alloy are thus quantified. One observation is that tantalum as γ′ former, for example within a temperature range between 1200° C. and 1300° C., diffuses to a much lesser degree because of the smaller coefficient of diffusion compared to titanium and aluminum. This relationship leads to the advantageous thermomechanical properties of the alloy composition presented. In particular, the slower or weaker diffusion can likewise slow the precipitation kinetics of the gamma prime phase and distinctly reduce susceptibility to cracking with regard to SAC. FIG. 1 may wholly or partly describe results of “Thermo-Calc” simulations.

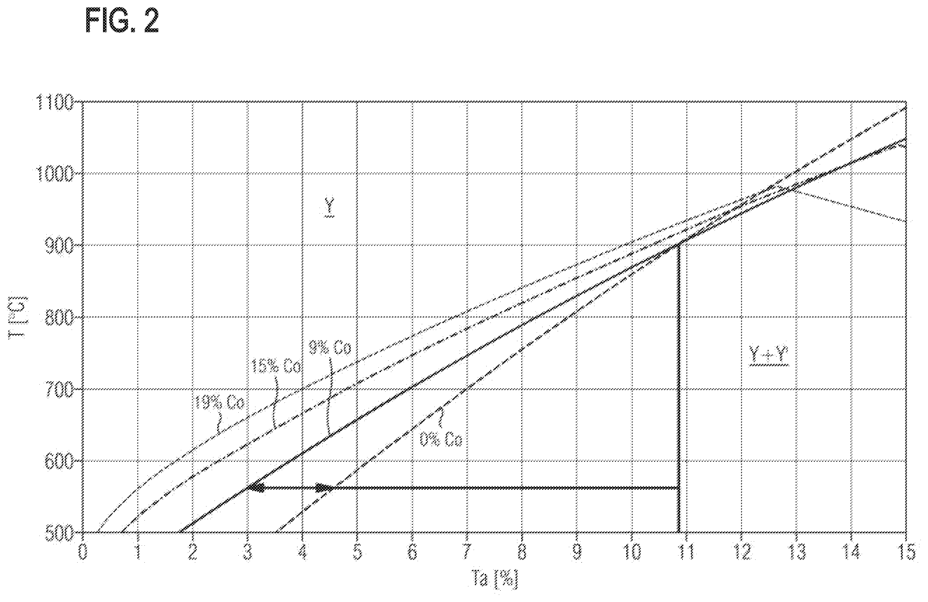

FIG. 2 shows, in a schematic phase diagram, the movement of the γ/γ′ precipitation phase region depending on temperature or technical synergistic effects of the elements cobalt and tantalum in the alloy composition presented.

Cobalt—at a given γ′ content—provokes reduction of the γ′ solvus temperature. A lower γ′ solvus temperature leads to slower γ′ precipitation kinetics and a lower driving force to γ′ formation. This likewise reduces the susceptibility to SAC, as already described above. On the other hand, it is possible, for a given γ′ solvus temperature, to increase the γ′ content at use temperatures of the corresponding component. Cobalt displaces tantalum from the γ matrix into the γ′ phase, which can increase the γ′ content. Moreover, it leads through the displacement to an elevated γ/γ′ lattice mismatch, which leads to an increase in strength via the γ′ phase. In order to illustrate the described effect of cobalt with reference to FIG. 2, the range between 0 and 9% Co in particular can be considered (cf. double-headed arrow), since alloys of corresponding composition at a level of about 11% tantalum (cf. vertical line) have about the same solvus temperature. At 9% cobalt, however, the γ′ content is higher at moderate temperatures than at a proportion of zero cobalt (cf. horizontal line). The lines drawn in in FIG. 2 thus illustrate the shift in the γ/γ′ phase region toward a larger γ′ content at the same solvus temperature. Cobalt itself thus does not necessarily directly reduce the γ′ solvus temperature, but does enable use of less tantalum, and hence achievement of the same γ′ content at lower solvus temperature. Increasing the Co content to 15% would enable, for example, lowering of Ta from 11% to 9% while still establishing a γ′ content of more than 20% and possibly lowering the solvus temperature.

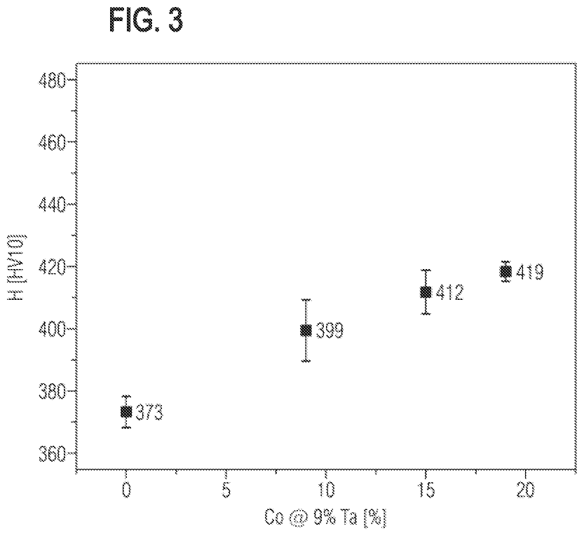

FIG. 3 shows the dependence of Vickers hardness H on the cobalt content of an alloy at a tantalum content of 9% by weight. The effects of the displacement effect described are manifested in the form of rising hardness with rising Co content of the alloy. In addition, the morphology of the γ′ phase changes from spherical to cubic as a result of the increase in Co content (not identified explicitly in the figures in the present context). This indicates that the Ta content in the γ′ phase increases with rising Co content, the lattice mismatch thus increases, and therefore the transformation of the morphology of the γ′ phase from spherical to cubic proceeds more quickly.

The actual additive process of manufacturing a component part from the alloy, which gives rise to a kind of (selectively melted) intermediate alloy, is typically followed by one or more heat treatments in order to establish a suitable microstructure. The first step of the heat treatment chain is typically an HIP process in order to close process-related porosity. The chosen temperature typically corresponds here to a solution annealing operation, which is ideally conducted above the γ′ solvus temperature and below the solidus temperature, for example between 1100° C. and 1300° C. Since the HIP process typically permits only gradual cooling, it is typically followed by another solution annealing operation under reduced pressure or under a protective gas atmosphere, for example for 2 to 8 hours, likewise between 1100° C. and 1300° C., with subsequent rapid cooling. For optimal creep resistance, the solution annealing is followed by single or multiple aging operations at temperatures between 700° C. to 950° C., for example for 12 to 48 hours.

A powder of the alloy or alloy composition described in the present context is typically produced in a vacuum inert gas jetting plant. In this plant, the alloy is melted in what is called a VIM oven and the liquid melt is held for 20 min to 2 hours for homogenization. The melt is directed into a pouring funnel that leads to a gas nozzle in which the molten metal is jetted under a high pressure of 5 to 100 bar with inert gas to give metal particles. The melt is heated in the melt crucible at 5 to 400° C. above the melting point. The metal flow rate in the jetting operation is 0.5 to 80 kg/min, and the gas flow rate 2 to 150 m³/min. The rapid cooling solidifies the metal particles in sphere form (spherical particles). The inert gas used in the jetting may if required contain 0.01 to 100% nitrogen. The gas phase is then separated from the powder in a cyclone, and then the powder is packed.

The particles here have a size (diameter) of 5 μm to 250 μm, gas inclusions of 0.0 to 4% of the pore area (pores smaller than 1 μm) relative to the total area of objects evaluated, and a bulk density of 2 up to the density of the alloy of about 8.5 g/cm³, and are packed airtight with argon under a protective gas atmosphere.

The range of spread for the particle size of the powder is between 5 and 250 μm, typical ranges being between 5 and 150 μm, or between 10 and 150 μm. The typical ranges are conducted by separating of excessively fine and excessively coarse particles with sieving and sifting processes. These processes are conducted under a protective gas atmosphere and can be conducted once or more than once. The inert gas in the powder production may either be argon or a mixture of argon with 0.01 to less than 100% nitrogen. Alternatively, the inert gas may possibly be helium. The inert gas should typically have a purity of at least 99.996% by volume. In particular, the nitrogen content should be 0 to 10 ppmv, the oxygen content from 0 to 4 ppmv, and the H2O content less than 5 ppmv.

The component part produced by an additive route from such an alloy powder may be a component part of a jet engine, for example a component part for the hot gas pathway of a gas turbine. In particular, the component part may be a rotor blade or guide vane, a ring segment, a burner part or a burner tip, a shroud, a shield, a heat shield, a nozzle, a seal, a filter, a spout or probe, a resonator, a ram or an agitator, or a corresponding transition or insert, or a corresponding retrofitted part.

It is understood that the foregoing description is that of the exemplary embodiments of the disclosure and that various changes and modifications may be made thereto without departing from the spirit and scope of the disclosure as defined in the appended claims.

What is claimed is:

1. A nickel-base alloy composition, comprising:
nickel as a main constituent; and
further constituents in % by weight:
0.04 to 0.10% carbon, typically 0.04 to 0.07% carbon,
8 to 13% tantalum,
12 to 20% chromium,
3 to 25% cobalt,
less than 0.03% manganese,
less than 0.06% silicon,
0 to 6% molybdenum,
less than 5.0% iron, typically less than 0.7% iron,
2 to 4% aluminum,
less than 0.01% magnesium,
less than 0.02% vanadium,
0 to 6% tungsten,
less than 1% titanium,
less than 0.03% yttrium,
0.005 to 0.015% boron,
less than 0.003% sulfur,
0.005 to 0.04% zirconium, and
less than 3% hafnium,
wherein:
a sum total of molybdenum and tungsten is 4% to 10%,
a ratio of tantalum to the sum total of aluminum, niobium, and titanium is 1.6 to 6.5,
the sum total of manganese and silicon is less than 0.07%, and
the ratio of chromium to aluminum is 3 to 10.

2. The alloy composition as claimed in claim 1, further comprising, in % by weight:
0.04 to 0.070% carbon,
9 to 12% tantalum,
14 to 16% chromium,
8 to 21% cobalt,
less than 0.01% manganese,
virtually zero % silicon,
2 to 3% molybdenum,
less than 0.7% iron,
3 to 3.5% aluminum,
about 0.001% magnesium,
virtually zero vanadium,
2 to 3% tungsten,
virtually zero titanium,
0 to 0.01% yttrium,
0.005 to 0.01% boron,
zero or virtually zero sulfur,
0.015 to 0.025% zirconium, and
less than 3% hafnium.

3. The alloy composition as claimed in claim 1, consisting of the further constituents apart from unavoidable impurities.

4. The alloy composition as claimed in claim 1, wherein the cobalt content is chosen so as not to give rise to any unwanted secondary phases, in particular any η phase.

5. The alloy composition as claimed in claim 1, wherein the chromium content is chosen so as to form a stable chromium oxide layer.

6. The alloy composition as claimed in claim 1, further comprising, in % by weight:
9 to 10% tantalum and 17 to 21% cobalt.

7. The alloy composition as claimed in claim 1, further comprising, in % by weight:
10 to 12% tantalum and 8 to 10% cobalt.

8. The alloy composition as claimed in claim 1, wherein a constituent of the sum total of boron and zirconium is additionally 0.01 to 0.045% by weight.

9. The alloy composition as claimed in claim 1, wherein the alloy composition is in powder form.

10. The alloy composition as claimed in claim 1, comprising a reduced γ′ solvus temperature in contrast to at least one of comparable and conventional alloys.

11. A method of manufacturing a component part, the method comprising:
manufacturing the component part from an alloy composition as claimed in claim 1,
wherein the method is an additive manufacturing method, and
wherein the additive manufacturing method is a powder bed method.

12. A method of additively manufacturing a component part, the method comprising:
at least partly melting a powder of the alloy composition as claimed in claim 1 with a laser or electron beam to produce the component part layer by layer.

13. The method as claimed in claim 12, further comprising:
after a hot isostatic pressing operation, subjecting a ready-made structure to a precipitation heat treatment comprising solution annealing, cooling and thermal aging to bring about precipitation hardening.

14. The method as claimed in claim 13, wherein the solution annealing comprises a heat treatment step for a period between 2 and 8 hours and between 1100° C. and 1300° C.

15. An intermediate alloy, comprising:
an alloy composition as claimed in claim 1, wherein the intermediate alloy is free of γ/γ′ phase precipitates.

16. A component part produced from a nickel-base superalloy of the alloy composition as claimed in claim 1, the component part comprising:
a structure which has a high γ′ content with an elevated γ/γ′ lattice mismatch.
